(19) United States
(12) Patent Application Publication
(10) Pub. No.: US 2022/0325496 A1
(43) Pub. Date: Oct. 13, 2022

(54) SYSTEM AND METHOD FOR PROTECTING A FOUNDATION WALL AGAINST EXTERIOR ENVIRONMENT

(71) Applicant: Marcel NICOLAS, Grande-Rivière (CA)

(72) Inventor: Marcel NICOLAS, Grande-Rivière (CA)

(21) Appl. No.: 17/718,896

(22) Filed: Apr. 12, 2022

Related U.S. Application Data
(60) Provisional application No. 63/173,672, filed on Apr. 12, 2021.

(51) Int. Cl. E02D 31/02; H05B 3/04; H05B 3/56

(52) U.S. Cl. CPC E02D 31/02; H05B 3/04; H05B 3/56; E02D 2600/10

(57) ABSTRACT

A system and method for protecting a foundation wall having an external side surface facing towards a soil and sitting on a top surface of a footing. The system includes a solid joint, adapted to be located adjacent and along an intersection of the side and top surfaces, that entirely and sealably covers the intersection and a lower portion of the side surface adjacent the intersection and at least a proximal portion of an external ledge of the top surface adjacent the intersection. The joint defines a free surface angled relative to both the external side surface and the top surface. In a cross section of the joint, the free surface, the lower portion and the at least a proximal portion form a triangular shape. A heating device extends along the joint and inside the triangular shape to selectively dissipate heat into the joint.

### CROSS-REFERENCE TO RELATED APPLICATIONS

This application claims priority of U.S. Provisional Application for Patent No. 63/173,672 filed Apr. 12, 2021, the content of which is incorporated herein by reference in its entirety.

### FIELD OF THE INVENTION

The present invention relates to concrete foundations, and more specifically to a system and method for protecting a foundation wall against exterior environment, such as moisture/water and freezing temperature.

### BACKGROUND OF THE INVENTION

The accumulation of water, and sometimes water pressure, along a foundation wall and/or under a concrete slab of a building can generate major problems to the building structure, without accounting for discomforts the building resident has to deal with. Water along a foundation wall and/or under a concrete slab, usually considered as the basement of the building, causes a high level (higher than normal comfortable level) of moisture, which might eventually dampen/damage sections of the walls and/or floor finishing. Other problems may occur on the concrete foundation itself. All these problems are even more present when there is a positive pressure along the wall and/or under the slab, or when excessive moisture or water permanently remains in the footing area.

Such water can be stagnant and remain along the wall and/or under the slab for extensive periods of time, if not permanently, depending on the soil type. Humidity can also reach the concrete slab from the interface between the foundation walls and the footing supporting the walls, with the concrete of the foundation walls not fully adhering to the footing, thereby leaving some interstices for water to reach the slab. Furthermore, since the concrete is known to be porous, it is further easy for water often accumulating at the outer periphery of the footing to slowly flow along the unsealed interface and reach the slab sitting on the inner periphery of the footing.

Commonly, particles are placed especially along the foundation walls to provide adequate drainage, which is a time consuming operation since this must be performed in stages (i.e. by increments of about 1-2 feet at a time, pouring particles, adjusting a landscape fabric membrane, filling the space between the landscape fabric membrane and the soil, and repeating the process) from the base of the foundation wall up towards the surface. This process is very labor intensive, requires specialized equipment for long durations of time and consequently is very expensive.

One way of protecting water from infiltrating the intersection or seam between the foundation wall and the footing, especially at the exterior thereof, is to have a filler block or joint filling the intersection, as illustrated in U.S. Pat. No. 6,634,144 to Moore et al. and U.S. Pat. No. 10,415,233 to Nicolas. Nonetheless, these solutions do not always prevent relatively high humidity level air, via moisture and/or water from being adjacent and in contact with the external surface of a foundation wall. This is even more important when the surrounding temperature could easily approach and drop below freezing temperature of about 0° C. (about 32° F.).

Accordingly, there is a need for an improved system and method for protecting a foundation wall against exterior environment.

### SUMMARY OF THE INVENTION

It is therefore a general object of the present invention to provide an improved system and method for protecting a foundation wall against exterior environment, and more specifically to a system and method to help in keeping moisture/water away from foundation wall sitting on a footing and provide insulation, that obviate the above-mentioned problems.

An advantage of the present invention is that the system and method ensures that the relative humidity level of the air adjacent and in contact with the foundation wall is controlled and maintained relatively low, thereby providing a relatively dry air environment (although not too dry) to the foundation wall, at least in the area adjacent the footing it sits on. The humidity control is typically done via a heating device, such as a heating electric wire or a hot fluid flowing into a sealed conduit or the like, running along the intersection between the foundation wall and the footing.

A further advantage of the present invention is that the system and method, especially when insulation foam boards are used in conjunction therewith to isolate the foundation wall from the adjacent soil, substantially no insulation is required on the inside of the foundation wall. In such a case, the inside surface of the foundation wall could be directly covered with a finishing coating or the like, thus reducing the overall cost of the finishing of the basement or the like.

According to an aspect of the present invention there is provided a system for protecting a foundation wall against environment, the foundation wall sitting on a top surface of a footing, the foundation wall having an external side surface facing towards a soil, the top surface having an outside edge thereof extending externally away from the external side surface and defining an external ledge of the footing therebetween, said system comprising:
a substantially solid joint adapted to be located adjacent and along an intersection of the external side surface of the foundation wall and the top surface of the footing, the joint entirely and sealably covering the intersection, and adapted to cover a first lower portion of the external side surface adjacent the intersection and at least a proximal portion of the external ledge adjacent the intersection, said joint defining a free surface angled relative to both the external side surface and the top surface, in a cross section of the joint, the free surface, the first lower portion of the external side surface and the at least a proximal portion of the external ledge forming a substantially triangular shape; and
a heating device extending along said joint and inside said triangular shape to selectively dissipate heat into said joint;

wherein the joint closes off the intersection to keep moisture/water away therefrom and the heating device warming up and drying air located adjacent the external side surface.

In one embodiment, the heating device is an electric resistive wire selectively dissipating heat when having electrical energy running there along, said system further including a temperature sensor, and a controller connecting to both the electric resistive wire and the temperature sensor, said controller selectively allowing electrical energy to run through said electric resistive wire when said temperature sensor senses a temperature being below a predetermined value.

Conveniently, the system includes a protective cover covering said electric resistive wire, and typically, said protective cover sealably protecting said electric resistive wire against water, and preferably, made of a metallic material.

Alternatively, the temperature sensor is located on said external side surface spaced from said joint.

Alternatively, the predetermined value is between about 3° C. and about 12° C.

Alternatively, the controller is mounted inside a building structure at least partially defined by the foundation wall.

Alternatively, the controller is a thermostat.

Alternatively, the joint hides and holds said heating device at the intersection.

In one embodiment, the system further includes a barrier device located adjacent said external side surface and separating both said joint and a second upper portion of the external side surface from the soil, the second upper portion extending from the first lower portion and above therefrom, away from the footing, said barrier device preventing surface contact between the soil and both said joint and the second upper portion of the external side surface.

Conveniently, the second upper portion extends from below said joint and said first lower portion up to above a soil surface.

Alternatively, the barrier device includes a layer of thermal insulation material, and typically a foam material.

Alternatively, the system further includes a spacer layer positioned between said barrier device and both said joint and the second upper portion of the external side surface, said spacer layer maintaining said barrier device spaced from said joint and the second upper portion, and being in surface contact with less than 50% of an external surface area of said joint and the second upper portion.

Alternatively, the barrier device is in surface contact with less than 50% of an external surface area of said joint and the second upper portion of the external side surface.

Conveniently, the barrier device includes a plurality of longitudinal spacers spaced from one another, and typically, the plurality of longitudinal spacers are oriented generally vertically along the foundation wall, and extend from the joint towards a soil surface.

In one embodiment, the joint is made out of settable concrete material, or includes at least one wedge block.

According to another aspect of the present invention there is provided a method for protecting a foundation wall against environment, the foundation wall sitting on a top surface of a footing, the foundation wall having an external side surface facing towards a soil, the top surface having an outside edge thereof extending externally away from the external side surface and defining an external ledge of the footing therebetween, said method comprising the steps of:
closing off the intersection to keep moisture/water away therefrom and from the foundation wall; and
providing a heating device adjacent and along the intersection.

In one embodiment, the step of closing off the intersection comprises:
installing a substantially solid joint along the intersection of the external side surface of the foundation wall and the top surface of the footing to sealably cover a first lower portion of the external side surface adjacent the intersection and at least a proximal portion of the external ledge adjacent the intersection, said joint defining a free surface angled relative to both the external side surface and the top surface, and, in a cross section of the joint, the free surface, the first lower portion of the external side surface and the at least a proximal portion of the external ledge forming a substantially triangular shape.

Conveniently, the step of providing a heating device comprises:
installing the heating device inside said triangular shape to selectively dissipate heat into said joint along the intersection.

Alternatively, the step of providing a heating device comprises:
hiding and holding said heating device at the intersection with said joint.

Alternatively, the method further comprises the step of:
providing a barrier device adjacent said external side surface and separating both said joint and a second upper portion of the external side surface from the soil, the second upper portion extending from the first lower portion and above therefrom, away from the footing, said barrier device preventing surface contact between the soil and both said joint and the second upper portion of the external side surface.

Conveniently, the step of providing a barrier device comprises:
spacing said barrier device from over at least 50% of an external surface area of said joint and the second upper portion of the external side surface.

Alternatively, the heating device is an electric resistive wire selectively dissipating heat when electrical energy running there along, and wherein said method further comprises the steps of:
providing a temperature sensor located on said external side surface spaced from said joint, and a controller connecting to both the electric resistive wire and the temperature sensor; and
selectively allowing electrical energy to run through said electric resistive wire via said controller when said temperature sensor senses a temperature being below a predetermined value.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figure, in which similar references used throughout denote similar components, wherein:

FIG. 1 is a broken elevation side section view of a system for protecting a foundation wall against exterior environment in accordance with an embodiment of the present invention.

### DETAILED DESCRIPTION OF THE INVENTION

With reference to the annexed drawings the preferred embodiments of the present invention will be herein described for indicative purpose and by no means as of limitation.

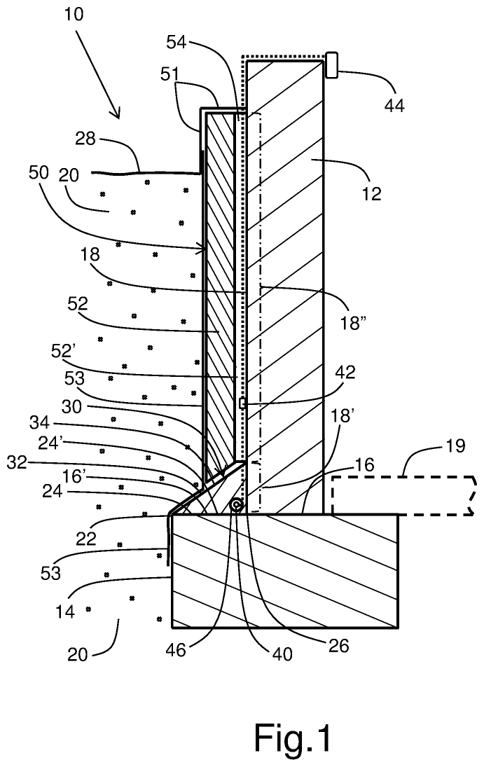

Referring to FIG. 1, there is shown a system 10 for protecting against environment (moisture/water and freezing temperatures) a foundation wall 12, typically in concrete, blocks (not shown) or the like, sitting on a top surface 16 of a concrete footing 14 in accordance with an embodiment of the present invention. The foundation wall 12 has an external side surface 18 facing towards a soil 20. The top surface 16 typically has an outside edge 22 thereof extending externally away from the external side surface 18 and defines an external ledge 24 of the footing 14 therebetween.

With particular reference to FIG. 1, the system 10 in accordance with the illustrative embodiment includes a substantially solid joint 30 adapted to be located adjacent and along an intersection 26 of the external side surface 18 of the foundation wall 12 and the top surface 16 of the footing 14. The joint 30, typically made of settable concrete or foam blocks (wedge blocks) adjacent one another or the like, entirely and sealably covers the intersection 26. The joint 30 is also adapted to cover a first lower portion 18′ of the external side surface 18 adjacent the intersection 26 and at least a proximal portion 24′, and typically entirely, of the external ledge 24 adjacent the intersection 26. The joint 30 defines a free surface 32 angled relative to both the external side surface 18 and the top surface 16. In a cross section of the joint 30, the free surface 32, the first lower portion 18′ of the external side surface 18 and the at least a proximal portion 24′ of the external ledge 24 form a substantially triangular shape 34. The free surface 32 essentially slopes downwardly away from the foundation wall 12 to ensure that no water/moisture could accumulate and remain on the joint and is therefore always drained away from the foundation wall 12 and the intersection 26.

The system 10 also includes a heating device 40 that extending along the joint 30 and inside the triangular shape 34 to selectively dissipate heat into the joint 30. Therefore, the joint 30 essentially closes off the intersection 26 to keep moisture/water away therefrom and the heating device 40 warms up and keeps the air located adjacent the external side surface 18 and the intersection 26 dry. The joint 30 essentially hides and holds the heating device 40 at the intersection 26.

Typically, the heating device 40 is an electric resistive wire selectively dissipating heat when having electrical energy running there along. The system 10 further includes a temperature sensor 42, and a controller 44 connecting to both the electric resistive wire 40 and the temperature sensor 42 (connections illustrated by dotted lines in FIG. 1 could run along and/or through the foundation wall 12). The controller 44 selectively allows electrical energy to run through the electric resistive wire 40 when the temperature sensor 42 senses or detects a temperature that is below a predetermined value, such as between about 3° C. and about 12° C., and preferably between about 5° C. and about 10° C. Typically, depending on the height of the foundation wall 12, the temperature sensor 42 is located on the external side surface 18 spaced from the joint 30, by about between 0-120 cm (about 0-48 in), and preferably about 5-30 cm (about 2-12 in). Also, especially to protect the electric resistive wire 40 from moisture/water, as well as to protect the surrounding elements/objects from melting/burning in case of malfunctioning, the electric resistive wire 40 is typically sealably covered by a protective cover 46 such as a suitable membrane, a rigid tubing or a metallic tubing. The controller 44 is preferably mounted inside the building structure (represented by a basement concrete slab 19—shown in dashed lines—sitting on the footing 14 adjacent the foundation wall 12 opposite and away the external side surface 18) at least partially defined by the foundation wall 12, or could also be located outside above a soil surface 28, and preferably partially protected from the elements such as under a patio or building entrance (not shown). The controller 44 could be similar to a conventional thermostat.

Although not specifically shown in the drawings, one skilled in the art would readily understand that any other heating device 40 could be considered without departing from the scope of the present invention, such as a hot fluid (as water or the like well-known fluid used in refrigeration/heating systems) flowing into a conduit adjacent the intersection 26.

Typically, the system 10 further includes a barrier device 50 located adjacent the external side surface 18 and that separates both the joint 30 and a second upper portion 18″ of the external side surface 18 from the soil 20. The second upper portion 18″ typically extends from the first lower portion 18′ and above therefrom, away from the footing 14, and preferably up to above the soil surface 28 (as illustrated in FIG. 1). When the barrier device 50 extends above the soil surface 28, that extension is typically covered with a finishing covering 51 (such as well-known parging and the like) for protection and aesthetic reasons. The barrier device 50 essentially prevents surface contact between the soil 20 and both the joint 30 and the second upper portion 18″ of the external side surface 18. The barrier device 50 typically includes a layer of thermal insulation material 52, such as for example a foam material (known as insulation foam panel material) or the insulating box-like device as described in U.S. Pat. No. 9,074,335. The barrier device 50 is typically in surface contact with less than 50% of an external surface area of the joint 30 and the second upper portion 18″ of the external side surface 18 to allow air (typically warm) to circulate there along. Typically, the barrier device 50 could include an outer membrane 53, such as a geotextile barrier, landscape fabric or the like, that prevent soil 20 from getting in direct contact with the system 10 and the foundation wall 12. Similarly, the barrier device 50 could also include a plurality of longitudinal spacers 52′ spaced from one another, such as conventional furring strips or the like. These spacers 52′ are typically oriented generally vertically along the foundation wall 18, and extend from the joint 30 towards a soil surface 28. Also, one skilled in the art would readily understand that any other types of spacers or mesh could be considered without departing from the scope of the present invention.

Alternatively, the system 10 could include spacer layer 54 positioned between the barrier device 50 and both the joint 30 and the second upper portion 18″ of the external side surface 18. The spacer layer 54 essentially maintains the barrier device 52 spaced from the joint 30 and the second upper portion 18″, and is in surface contact with less than 50% of the external surface area of the joint 30 and the second upper portion 18″. Such a spacer layer could, for example be similar to a commonly known Delta™ membrane system from the Ewald Dörken AG company from Herdecke, Germany (also Darken Systems Inc. company of North America). The spacer layer 54 further ensure that air may freely low or circulate there along and to be in fluid communication with the outdoor ambient air, to allow excess humidity (into the air within the space between the barrier device 50 and the upper portion 18″ of the external side surface 18) to naturally escape therefrom.

In accordance with another aspect of the present invention, there is provided a method for protecting a foundation wall 12 against environment. The method typically comprises the steps of:
closing off the intersection 26 to keep moisture/water away therefrom and from the foundation wall 12; and
providing a heating device 40 adjacent and along the intersection 26.

Typically, the step of closing off the intersection comprises installing a substantially solid joint 30 along the intersection 26 of the external side surface 18 of the foundation wall 12 and the top surface 16 of the footing 14 to sealably cover a first lower portion 18′ of the external side surface 18 adjacent the intersection 26 and at least a proximal portion 16′ of the external ledge 24 adjacent the intersection 26.

Conveniently, the step of providing a heating device 40 comprises installing the heating device 40 inside the triangular shape to selectively dissipate heat into the joint 30 along the intersection 26.

Alternatively, the step of providing a heating device 40 comprises hiding and holding the heating device 40 at the intersection 26 with the joint 30 that essentially retains the heating device 40 in place.

In addition, the method could further comprise the step of providing a barrier device 50 adjacent the external side surface 18 and separating both the joint 30 and the second upper portion 18″ of the external side surface 18 from the soil 20. That step may further comprise spacing the barrier device 50 from the joint 30 and the second upper portion 18″, over at least 50% of the external surface area of the joint and the second upper portion 18″ of the external side surface 18. This spacing allows for the air filling it to be selectively warmed and dried by the heating device 40 adjacent the joint 30 and flow within that spacing to protect the joint 30 and the foundation wall 12 from the environment.

Alternatively, when the heating device 40 is an electric resistive wire selectively dissipating heat when electrical energy runs there along, method further comprises the steps of:
providing a temperature sensor 42 located on the external side surface 18 spaced from the joint 30, and a controller 44 connecting to both the electric resistive wire 40 and the temperature sensor 42; and
selectively allowing electrical energy to run through the electric resistive wire 40 via the controller 44 when the temperature sensor 42 senses a temperature being below a predetermined value.

Although the present invention has been described with a certain degree of particularity, it is to be understood that the disclosure has been made by way of example only and that the present invention is not limited to the features of the embodiments described and illustrated herein, but includes all variations and modifications within the scope of the invention as hereinafter claimed.

I claim:

1. A system for protecting a foundation wall against environment, the foundation wall sitting on a top surface of a footing, the foundation wall having an external side surface facing towards a soil, the top surface having an outside edge thereof extending externally away from the external side surface and defining an external ledge of the footing therebetween, said system comprising:
a substantially solid joint adapted to be located adjacent and along an intersection of the external side surface of the foundation wall and the top surface of the footing, the joint entirely and sealably covering the intersection, and adapted to cover a first lower portion of the external side surface adjacent the intersection and at least a proximal portion of the external ledge adjacent the intersection, said joint defining a free surface angled relative to both the external side surface and the top surface, in a cross section of the joint, the free surface, the first lower portion of the external side surface and the at least a proximal portion of the external ledge forming a substantially triangular shape; and
a heating device extending along said joint and inside said triangular shape to selectively dissipate heat into said joint;
wherein the joint closes off the intersection to keep moisture/water away therefrom and the heating device warming up and drying air located adjacent the external side surface.

2. The system of claim 1, wherein said heating device is an electric resistive wire selectively dissipating heat when having electrical energy running there along, said system further including a temperature sensor, and a controller connecting to both the electric resistive wire and the temperature sensor, said controller selectively allowing electrical energy to run through said electric resistive wire when said temperature sensor senses a temperature being below a predetermined value.

3. The system of claim 2, further including a protective cover covering said electric resistive wire.

4. The system of claim 2, wherein said temperature sensor is located on said external side surface spaced from said joint.

5. The system of claim 2, wherein said predetermined value is between about 3° C. and about 12° C.

6. The system of claim 2, wherein said controller is mounted inside a building structure at least partially defined by the foundation wall.

7. The system of claim 2, wherein said joint hides and holds said heating device at the intersection.

8. The system of claim 1, further including a barrier device located adjacent said external side surface and separating both said joint and a second upper portion of the external side surface from the soil, the second upper portion extending from the first lower portion and above therefrom, away from the footing, said barrier device preventing surface contact between the soil and both said joint and the second upper portion of the external side surface.

9. The system of claim 8, wherein the second upper portion extends from below said joint and said first lower portion up to above a soil surface.

10. The system of claim 8, wherein said barrier device includes a layer of thermal insulation material.

11. The system of claim 10, wherein said thermal insulation material is a foam material.

12. The system of claim 8, further including a spacer layer positioned between said barrier device and both said joint and the second upper portion of the external side surface, said spacer layer maintaining said barrier device spaced from said joint and the second upper portion, and being in surface contact with less than 50% of an external surface area of said joint and the second upper portion.

13. The system of claim 8, wherein said barrier device is in surface contact with less than 50% of an external surface area of said joint and the second upper portion of the external side surface.

14. The system of claim 13, wherein said barrier device includes a plurality of longitudinal spacers spaced from one another.

15. The system of claim 14, wherein said plurality of longitudinal spacers are oriented generally vertically along the foundation wall, and extend from the joint towards a soil surface.

16. The system of claim 1, wherein said joint is made out of settable concrete material, or includes at least one wedge block.

17. A method for protecting a foundation wall against environment, the foundation wall sitting on a top surface of a footing, the foundation wall having an external side surface facing towards a soil, the top surface having an outside edge thereof extending externally away from the external side surface and defining an external ledge of the footing therebetween, said method comprising the steps of:
closing off the intersection to keep moisture/water away therefrom and from the foundation wall; and
providing a heating device adjacent and along the intersection.

18. The method of claim 17, wherein the step of closing off the intersection comprises:
installing a substantially solid joint along the intersection of the external side surface of the foundation wall and the top surface of the footing to sealably cover a first lower portion of the external side surface adjacent the intersection and at least a proximal portion of the external ledge adjacent the intersection, said joint defining a free surface angled relative to both the external side surface and the top surface, and, in a cross section of the joint, the free surface, the first lower portion of the external side surface and the at least a proximal portion of the external ledge forming a substantially triangular shape.

19. The method of claim 18, wherein the step of providing a heating device comprises:
installing the heating device inside said triangular shape to selectively dissipate heat into said joint along the intersection.

20. The method of claim 18, wherein said heating device is an electric resistive wire selectively dissipating heat when electrical energy running there along, and wherein said method further comprises the steps of:
providing a temperature sensor located on said external side surface spaced from said joint, and a controller connecting to both the electric resistive wire and the temperature sensor; and
selectively allowing electrical energy to run through said electric resistive wire via said controller when said temperature sensor senses a temperature being below a predetermined value.
